(19) United States
(12) Patent Application Publication
(10) Pub. No.: US 2024/0049744 A1
(43) Pub. Date: Feb. 15, 2024

(54) METHOD FOR EXTRACTING PULSE PROTEINS

(71) Applicant: COSUCRA GROUPE WARCOING S.A., Warcoing (BE)

(72) Inventors: Christian FOUGNIES, Peruwelz (BE); Julie LEBESGUE, Mouchin (FR); Léandro GALVAN D'ALESSANDRO, Haubourdin (FR); Nicolas ROMANO, Dottignies (BE); Justine MAES, Peissant (BE)

(73) Assignee: COSUCRA GROUPE WARCOING S.A., Warcoing (BE)

(21) Appl. No.: 18/265,307

(22) PCT Filed: Dec. 23, 2021
(86) PCT No.: PCT/EP2021/087458

§ 371 Date: Jun. 5, 2023

(30) Foreign Application Priority Data
Dec. 23, 2020 (EP) 20217172.4

(51) Int. Cl. A23J 1/14; A23L 33/185

(52) U.S. Cl. CPC A23J 1/14; A23L 33/185

(57) ABSTRACT

The present invention relates to a pulse protein composition, preferably faba bean protein composition that has a protein content of at least 60 wt % by weight based on dry matter, a nitrogen solubility index at pH ranging from 4.5 to 5.5 of at least 20%, preferably of at least 15% and at pH of 3.5 of at least 20%, preferably of at least 40%, as measured on a aqueous composition comprising 3 wt % of said pulse protein composition based on the total weight of the aqueous composition and optionally a viscosity of at most 2000 cP at pH 6.5. The invention further relates to methods for extracting pulse proteins, preferably faba bean protein. The invention further relates to pulse protein composition obtainable by the above methods, as well as food or feed products containing such pulse protein composition. The invention also relates to the use of such pulse protein composition in food or feed industry.

### FIELD OF THE INVENTION

The present invention relates to a pulse protein composition, preferably faba bean protein composition. The invention further relates to methods for extracting pulse proteins, preferably faba bean protein. The invention further relates to pulse protein composition obtainable by the above methods, as well as food or feed products containing such pulse protein composition. The invention also relates to the use of such pulse protein composition in food or feed industry.

### BACKGROUND OF THE INVENTION

Protein isolates from plant origin represent a valuable alternative or supplement to animal proteins in foods or feeds. For instance, in foods, addition of plant proteins can effectively replace animal proteins, often at lower cost. In addition, many products traditionally containing animal proteins, in particular dairy products, may be a major cause of food allergies.

Leguminosae or pulses are notable in that most of them have symbiotic nitrogen-fixing bacteria in structures called root nodules. This arrangement means that the root nodules are sources of nitrogen for pulse, making them relatively rich in plant proteins. All proteins contain nitrogenous amino acids. Nitrogen is therefore a necessary ingredient in the production of proteins. Hence, pulses are among the best sources of plant protein.

As pulses, besides having a high protein content, are readily available and have a particularly well-balanced amino acid composition, these represent a protein source which is a valuable alternative for animal proteins.

The main challenges related to the production of vegetable proteins revolve around the composition and purity of the proteins, as well as the environmental impact of the process used, and include aspects such as extraction, fractionation and pre- and post-isolation treatments. As can be appreciated from the above, obtaining a high-quality protein isolate with desired specific properties can be cumbersome and often involves multiple costly and/or time-consuming manipulations. In this context, there is always a need to improve the isolation of proteins from plants, especially pulses.

By the time the plant protein is isolated and available in a more or less pure form, all prior manipulations have a significant impact on the quality of the isolated plant protein as well as on the environmental impact of the process used. For example, the type and amount of impurities in the protein isolates or extracts determine its final value. In addition to the impact on the final composition of the protein isolates or extracts, the extraction and/or purification process can have a considerable impact on the physico-chemical or functional properties of the protein isolate. In particular, the solubility, viscosity, emulsification capacity, color, taste or odor of proteins are strongly influenced by the techniques used. The protein at the end can be more or less denatured which will impact its behavior.

Gueguen, “Legume seed protein extraction, processing, and end product characteristics» 1983 Qual Plant Plant Foods Hum Nutr 32 p267-303; describes a process of preparation of faba bean protein isolate.

It is accordingly one of the objects of the present invention to provide an improved process, for extracting pulse protein, that is to say, a process more economical and having a low carbon print impact and while keeping a protein as native as possible (or as less denatured as possible).

### SUMMARY OF THE INVENTION

According to a first aspect of the present invention, a pulse protein composition is provided. The pulse protein composition is characterized by having:
a protein content at least 60 wt % based on dry matter, and
a nitrogen solubility index at a pH ranging from 4.5 to 5.5 of at most 20% (such as ranging from 2% to 20%), preferably of at most 15% (such as 2% to 15%) and a nitrogen solubility index at pH of (at most) 3.5, preferably at pH of (at most) 3.8 of at least 20%, preferably at least 30%, such as at least 40%. (as measured on an aqueous composition comprising 3 wt % of said pulse protein composition based on the total weight of the aqueous composition).

According to a second aspect of the present invention, a method for extracting pulse protein composition is provided and pulse protein extraction involves coarsely grinding pulse seeds and hydrating these coarsely ground pulse seeds. The aqueous hydrating solution is removed before milling the coarsely ground pulse seeds into a flour. During or after milling, pulse proteins are separated and isolated. Downstream purification steps are also envisaged.

According to a third aspect of the present invention, pulse protein composition is provided which is obtainable or obtained by the method according to the second aspect of the invention.

According to a fourth aspect of the present invention, an edible composition is provided, preferably a food or feed product, comprising the pulse protein composition according to the first aspect of the invention, or pulse protein composition obtained by the method according to the third aspect of the invention.

In a fifth aspect, the present invention provides the use of pulse protein composition according to the first aspect of the invention, or pulse protein composition obtained by the method according to the third aspect of the invention in food or feed products, preferably, in dairy products, confectionary products, beverages, meat products, vegetarian products, food supplements, nutritional products destined to weight control, sports, medical food and food for elderly, and in bakery food products.

The present inventors have surprisingly found that coarsely grinding the pulse seeds affects the hydration step and physical-chemical properties of the protein composition.

The aqueous hydrating solution is removed before milling the coarsely ground pulse seeds into a flour. If hydration is performed on flour, the resulting protein extract will have different physico-chemical characteristics, compared to hydration of coarsely ground pulses according to the present invention.

Contrary to expectations, the inventors have found that, compared to a process starting with pulse flour and using an isoelectric precipitation of the proteins, the purity of the protein composition obtained by the process described in the present invention is comparable to the purity obtained via a process comprising isoelectric precipitation. Surprisingly, a purification step after removal of the fibers and starch from the protein composition is not required in order to have a good purity of the protein composition.

Without wishing to be bound to theory, it is believed that this process further preserves the native character of the extracted proteins. Isoelectric precipitation of the proteins is a step that induces important structural and/or functional modifications of the proteins. As a consequence, the properties of the protein composition obtained by the present invention will be different from the protein composition obtained by methods using isoelectric precipitation of the proteins.

Moreover, one advantage is that a higher overall protein yield can be obtained, without decreasing purity of the protein composition of the present invention.

Advantageously, there is therefore less nitrogen in the altogether effluent which allows to minimize the amount of for instance water and energy consumption in downstream processes, such as further purification. This provides therefore an economical advantage as nitrogen is expensive to eliminate.

Isoelectric precipitation of the protein is a very expensive step. During this step, mineral acids are used (H₂SO₄, HCL, citric acid, . . . ) to decrease the pH of the protein composition. Economies are made because of saving of reagent and sulfates to be treated in purification. Moreover, there is no return to alkaline pH (saving of KOH or NaOH) after the isoelectric precipitation of the protein of the protein composition. According to the invention, the pulse protein composition contains less sodium than the protein composition obtained by the prior art using mineral base like NaOH. Finally, after isoelectric precipitation step, there is a step of separation using decantation which is an expensive step because of the investment in equipment and the complexity of this stage.

The independent and dependent claims set out particular and preferred features of the invention. Features from the dependent claims may be combined with features of the independent or other dependent claims as appropriate. The appended claims are hereby also explicitly included by reference in the description.

### BRIEF DESCRIPTION OF THE FIGURES

FIG. 1 Scheme of the process according to an embodiment of the present invention.

FIG. 2 Solubility profile of faba bean protein compositions according to an embodiment of the present invention and according to a faba bean protein obtained by a process using isoelectric precipitation.

FIG. 3 Viscosity profile of faba bean protein compositions according to an embodiment of the present invention and according to a faba bean protein obtained by a process using isoelectric precipitation.

FIG. 4: HPSEC profile of faba bean protein compositions according to an embodiment of the invention and according to a faba bean protein obtained by a process using isoelectric precipitation.

### DETAILED DESCRIPTION OF THE INVENTION

Before the present method of the invention is described, it is to be understood that this invention is not limited to particular methods, components, products or combinations described, as such methods, components, products and combinations may, of course, vary. It is also to be understood that the terminology used herein is not intended to be limiting, since the scope of the present invention will be limited only by the appended claims.

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”, as well as the terms “consisting essentially of”, “consists essentially” and “consists essentially of”.

The recitation of numerical ranges by endpoints includes all numbers and fractions subsumed within the respective ranges, as well as the recited endpoints.

The term “about” or “approximately” as used herein when referring to a measurable value such as a parameter, an amount, a temporal duration, and the like, is meant to encompass variations of +/−20% or less, preferably +/−10% or less, more preferably +/−5% or less, and still more preferably +/−1% or less of and from the specified value, insofar such variations are appropriate to perform in the disclosed invention. It is to be understood that the value to which the modifier “about” or “approximately” refers is itself also specifically, and preferably, disclosed.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

All references cited in the present specification are hereby incorporated by reference in their entirety. In particular, the teachings of all references herein specifically referred to are incorporated by reference.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

In the following detailed description of the invention, reference is made to the accompanying drawings that form a part hereof, and in which are shown by way of illustration only of specific embodiments in which the invention may be practiced. It is to be understood that other embodiments may be utilized, and structural or logical changes may be made without departing from the scope of the present invention. The following detailed description, therefore, is not to be taken in a limiting sense, and the scope of the present invention is defined by the appended claims.

Hereto, the present invention is in particular captured by any one or any combination of one or more of the below aspects and embodiments and numbered statements 1 to 48.

1. A pulse protein composition characterized by having:
a protein content of at least 60 wt % based on dry matter (such as ranging from 60 wt % to 90 wt % or from 60 wt % to 85 wt %), and
a nitrogen solubility index at a pH ranging from 4.5 to 5.5 of at most 20% (such as ranging from 2% to 20%), preferably of at most 15% (such as 2% to 15%) and a nitrogen solubility index at pH of (at most) 3.5, preferably at pH of (at most) 3.8 of at least 20%, preferably at least 30%, such as at least 40%.

2. The pulse protein composition according to statement 1, characterized in that by having a nitrogen solubility index at a pH of at least 7 (or ranging from 7 to 8) of at least 70%, preferably of at least 80%.

3. The pulse protein composition according to statement 1 or 2, characterized in that by having an enthalpy of at least 4.5 (ΔH J/g), preferably of at least 5.5 measured by DSC (Differential scanning calorimetry).

4. The pulse protein composition according to any one of statements 1 to 3, characterized in that the pulse protein composition has a viscosity of at most 2000 cP at pH 6.5, preferably at most 1800 cP, such as ranging from 50 cP to 2000 cP or from 50 cP to 1800 cP.

5. The pulse protein composition according to any one of statements 1 to 4, characterized in that the pulse protein composition has a sodium content of at most 1 wt % on dry matter, preferably of at most 0.7 wt % on dry matter.

6. The pulse protein composition according to any one of statements 1 to 5, characterized in that the pulse protein composition has an emulsion capacity of at least 600 g oil/g protein.

7. The pulse protein composition according to any one of statements 1 to 6, characterized in that the pulse protein composition has a gel strength of at most 150 g, preferably of at most 130 g.

8. The pulse protein composition according to claim 1, characterized in that the nitrogen solubility was measured on an aqueous composition comprising 3 wt % of said pulse protein composition based on the total weight of the aqueous composition.

9. Method for extracting pulse protein composition, the method comprising the following steps:

(a) coarsely grinding pulses so as to obtain coarsely ground pulses;

(b) bringing coarsely ground pulses into contact with an aqueous solution in order to form an aqueous composition comprising coarsely ground pulses;

(c) leaving the coarsely ground pulses to hydrate in said aqueous composition thereby obtaining hydrated coarsely ground pulses;

(d) removing aqueous solution from the aqueous composition comprising hydrated coarsely ground pulses;

(e) wet milling said hydrated coarsely ground pulses; thereby obtaining milled pulses;

(f) fractionating said milled pulses so as to obtain pulse protein composition.

10. The method according to statement 9, wherein before or during step (a) the pulse seed has been dehulled.

11. The method according to statement 9 or 10, wherein
at most 25% of coarsely ground pulses in step (a) have a diameter equal or less than 500 μm, preferably at most 20% of coarsely ground pulses in step (a) have a diameter equal or less than 500 μm, more preferably at most 15% of coarsely ground pulses in step (a) have a diameter equal or less than 500 μm and
10 to 50% of coarsely ground pulses in step (a) have a diameter equal or more than 2 mm, more preferably 15 to 45% of coarsely ground pulses in step (a) have a diameter equal or more than 2 mm.

12. The method according to any one of statement 9 to 11, wherein said coarsely ground pulses in step (a) have been obtained by dry grinding.

13. The method according to any one of statements 9 to 12, wherein said aqueous composition comprising coarsely ground pulses in step (b), comprises an aqueous solution, preferably water.

14. The method according to any one of statements 9 to 13, wherein step (b) comprises bringing coarsely ground pulses into contact with an aqueous solution at a ratio aqueous solution/coarsely ground pulse ranging from 15/1 to 5/1, preferably from 10/1 to 8/1.

15. The method according to any one of statements 9 to 14, wherein step (c) comprises leaving the coarsely ground pulses to hydrate at a temperature ranging from 4° C. to 50° C., preferably from 15° C. to 45° C.

16. The method according to any one of statements 9 to 15, wherein step (c) comprises leaving the coarsely ground pulses to hydrate at a pH of the aqueous solution ranging from 4 to 7, preferably from 4.5 to 6.5. This pH adjustment (if or when needed) can be performed using any suitable acid, such as hydrochloric acid, citric acid, lactic acid.

17. The method according to any one of statements 9 to 16, wherein step (c) comprises leaving the coarsely ground pulses to hydrate at a pH ranging from 4 to 7, preferably from 4.5 to 6.5. This pH adjustment (if or when needed) can be performed using any suitable acid, such as hydrochloric acid, citric acid, lactic acid.

18. The method according to any one of statements 9 to 17, wherein step (c) comprises leaving the coarsely ground pulses to hydrate for at least 5 minutes and at most 5 hours, preferably at least 5, at least 10, at least 20, at least 30, at least 45, at least 60, at least 90, at least 120, at least 180, at least 240 minutes; preferably at most 5, at most 4, at most 3 hours; preferably at least 5, at least 10, at least 20, at least 30, at least 45, at least 60, at least 90, at least 120, at least 180, at least 240 minutes and at most 5, at most 4, at most 3 hours.

19. The method according to any one of statements 9 to 18, wherein between step (d) and step (e) the hydrated coarsely ground pulses are washed at least one time with an aqueous solution, preferably at least two, at least 3; preferably from 1 to 3, or from 1 to 2.

20. The method according to any one of statements 9 to 19, wherein before, during and/or after the milling step (e) an aqueous solution is added, preferably water, preferably such as to obtain an aqueous composition comprising the milled pulses,

21. The method according to statement 20, wherein said aqueous composition comprising the milled pulses comprises from 5% to 30% dry matter based on the total weight of the composition, preferably comprising from 10% to 25%, preferably from 12% to 25%, for example from 10% to 20%, such as at least 10%, for example at least 11%, for example at least 12%, for example at least 13%, for example at least 14%, for example at most 25%.

22. The method according to any one of statements 9 to 21, wherein fractionating said milled pulses in step (f) comprises adjusting the pH of the milled pulses to a pH of at least 6, preferably at least 7, most preferably a pH of at least 8 and of at most 9. This pH adjustment can be performed using any suitable base, such as sodium hydroxide, potassium hydroxide, calcium hydroxide.

23. The method according to any one of statements 9 to 22, wherein fractionating said milled pulses in step (f) comprises subjecting said milled pulses to one or more separation steps, preferably one or more decantation steps, preferably one or more centrifugal decantation steps.

24. The method according to any one of statements 9 to 23, wherein fractionating said milled pulses in step (f) comprises separating at least part of the proteins comprised in the pulses from the rest of the pulse, preferably in a fraction comprising at least 50 wt % of protein based on the total dry matter of said fraction.

25. Method according to any one of statements 9 to 24, wherein during step (c), the pulses are subjected to fermentation.

26. Method according to statement 25, wherein the fermentation is in the presence of lactic acid bacteria.

27. Method according to statement 26, wherein lactic acid bacteria are Lactobacillus sp, most preferably selected from the group consisting of Lactobacillus fermentum, Lactobacillus crispatus, Lactobacillus panis, Lactobacillus mucosae, Lactobacillus pontis, Lactobacillus acidophilus, Lactobacillus plantarum, Lactobacillus helveticus, Lactobacillus buchneri, Lactobacillus delbrueckii, and Lactobacillus casei, and mixtures thereof.

28. The method according to any one of statements 9 to 27, wherein after step (f) the method further comprises steps

(g) subjecting said pulse protein composition to at least one heat treatment and/or

(h) drying said pulse protein composition.

29. The method according to statement 28, wherein step (g) comprises subjecting said pulse protein composition to a heat treatment for at least 0.02 second, preferably for a time ranging from 0.02 second to 20 minutes, preferably ranging from 10 seconds to 10 minutes.

30. The method according to any one of statements 28 or 29, wherein said heat treatment in step (g) is performed at a temperature of at least 30° C., preferably at a temperature ranging from 50° C. to 150° C., preferably ranging from 70° C. to 110° C., for example from 70° C. to 125° C.

31. The method according to any one of statements 28 to 30, wherein said heat treatment in step (g) is performed at a temperature ranging from 65° C. to 150° C. for a time ranging from 20 s to 0.02 s; at a temperature ranging from 95° C. to 115° C. for a time ranging from 5 min to 5 s; at a temperature ranging from 70° C. to 100° C. for a time ranging from 15 min to 10 s; at a temperature ranging from 75° C. to 110° C. for a time ranging from 10 min to 15 s; at a temperature ranging from 80° C. to 100° C. for a time ranging from 8 min to 5 s; or at a temperature ranging from 110° C. to 140° C. for a time ranging from 8 s to 0.02 s.

32. The method according to any one of statements 9 to 31, wherein step (f) comprises isolating said pulse proteins as an extract comprising at least 60 wt %, preferably at least 70 wt %, more preferably at least 80 wt %, for example at least 85 wt % of protein based on the total dry matter of said extract.

33. The method according to any one of statements 9 to 32, wherein the overall protein yield is ranging from 10 to 30 wt %, preferably ranging from 15 to 30 wt %, more preferably ranging from 20 to 30 wt %.

34. Pulse protein obtainable by the method according to any one of statements 9 to 33.

35. An edible composition, preferably a food or feed product, comprising the pulse proteins composition according to statement 1 to 8 or statement 34.

36. Use of pulse proteins composition according to statement 1 to 8 or statement 34 or 35 in food or feed products, preferably, in dairy products, confectionary products, beverages, acidic beverages, meat products, vegetarian products, food supplements, nutritional products destined to weight control, sports, medical food and food for elderly, and bakery food products.

37. Method for purifying pulse protein composition comprising the step of using the method according to any one of statements 9 to 33.

38. A pulse protein composition characterized by having:
a protein content of at least 60 wt % based on dry matter (such as ranging from 60 wt % to 90 wt % or from 60 wt % to 85 wt %), and
an enthalpy (ΔH J/g) of at least 4.5 measured by DSC (Differential scanning calorimetry).

39. The pulse protein composition according to statement 38, characterized in that by having a nitrogen solubility index at a pH ranging from 4.5 to 5.5 of at most 20% (such as ranging from 2% to 20%), preferably of at most 15% (such as 2% to 15%) and a nitrogen solubility index at pH of (at most) 3.5, preferably at pH of (at most) 3.8 of at least 20%, preferably at least 30%, such as at least 40%.

40. The pulse protein composition according to statement 38 or 39, characterized in that by having a nitrogen solubility index at a pH of at least 7 (or ranging from 7 to 8) of at least 70%, preferably of at least 80%.

41. The pulse protein composition according to any one of statements 38 to 40, characterized in that by having a nitrogen solubility index at a pH of (at most) 4.0 of at least 20%, preferably of at least 30%.

42. The pulse protein composition according to any one of statements 38 to 41 characterized in that the pulse protein composition has a viscosity of at most 2000 cP at pH 6.5, preferably at most 1800 cP, such as ranging from 50 cP to 2000 cP or from 50 cP to 1800 cP.

43. The pulse protein composition according to any one of statements 38 to 42, characterized in that the pulse protein composition has a sodium content of at most 1 wt % on dry matter, preferably of at most 0.7 wt % on dry matter.

44. The pulse protein composition according to any one of statements 38 to 43 characterized in that the pulse protein composition has an emulsion capacity of at least 600 g oil/g protein.

45. The pulse protein composition according to any one of statements 38 to 44, characterized in that the pulse protein composition has a gel strength of at most 150 g, preferably of at most 130 g.

46. The pulse protein composition according to any one of statement 39 to 41, characterized in that the nitrogen solubility was measured on an aqueous composition comprising 3 wt % of said pulse protein composition based on the total weight of the aqueous composition;

47. An edible composition, preferably a food or feed product, comprising the pulse proteins composition according to statement 38 to 46 or statement 34.

48. Use of pulse proteins composition according to statement 38 to 46 or statement 34 or 47 in food or feed products, preferably, in dairy products, confectionary products, beverages, acidic beverages, meat products, vegetarian products, food supplements, nutritional products destined to weight control, sports, medical food and food for elderly, and bakery food products.

In an embodiment, the invention relates to a pulse protein composition characterized by having:
a protein content of at least 60 wt % based on dry matter,
a nitrogen solubility index at a pH ranging from 4.5 to 5.5 of at most 20%, preferably of at most 15% and a nitrogen solubility index at a pH of (at most) 3.5 of at least 20%, preferably of at least 40%.

As used herein, the term “pulse” refers to the dried seeds of legumes. The four most common pulses are beans, chickpeas, lentils and peas. Lentils, as Lens Culinaris, are represented by: Beluga Lentils, Brown Lentils, French Green Lentils, Green Lentils and Red Lentils. Beans, as Phaseolus Vulgaris, are represented by: Adzuki Beans, Anasazi Beans, Appaloosa Beans, Baby Lima Beans, Black Calypso Beans, Black Turtle Beans, Dark Red Kidney Beans, Great Northern Beans, Jacob's Cattle Trout Beans, Large Faba Beans, Large Lima Beans, Mung Beans, Pink Beans, Pinto Beans, Romano Beans, Scarlet Runner Beans, Tongue of Fire, White Kidney Beans and White Navy Beans. Peas are represented by: Black-Eyed Peas, Green Peas, Marrowfat Peas, Pigeon Peas, Yellow Peas and Yellow-Eyed Peas. Chickpeas, as Cicer Arietinum, are represented by: Chickpea and Kabuli.

According to the invention, the pulses may be whole pulses, i.e. pulses as they are present in the pod. Pulses may however in an embodiment be split pulses. In an embodiment, the pulses are round when harvested and dry. After the hull is removed, the natural split in the seed's cotyledon can be manually or mechanically separated, resulting in “split pulses”. In a preferred embodiment, the pulses are dehulled, i.e. pulses from which the hull is removed. Dehulled pulses are pulses from which the outer seed coating is removed. Removing of the hull can be performed by techniques known in the art, such as for instance mechanically with dehullers. It is to be understood that when referring herein to dehulled pulses, in some embodiments, not all but nevertheless the vast majority of individual pulses are dehulled, such as preferably more than 90% of the pulses are dehulled.

Pulses as used herein may be sorted prior to subjecting to coarse grinding. For instance, stones or larger plant material, but also damaged pulses, may be removed from the pulses to be used according to the invention.

As used herein, the term “faba bean” or “fava bean” refers to the round seeds contained in the pod of Faba beans (Vicia faba L.) also referred to as broad beans, horse beans, or field beans.

In a preferred embodiment, faba bean is used. Dry faba bean contains 25-33 wt % proteins. Faba bean proteins are mainly storage proteins comprised of albumins and mainly two globulins, legumin and vicilin. Solubility profile of faba bean protein composition is similar to other legume proteins and is characterized by high solubility at alkaline pH-s, a minimum solubility at isoelectric point and moderate solubility in acidic medium.

The pulse protein composition obtained by the methods according to the present invention as described herein have different characteristics, such as different biochemical and/or organoleptic characteristics, as well as a difference in quality associated parameter values compared to known prior art pulse proteins.

Accordingly, the present invention also encompasses pulse proteins, pulse protein extracts, and pulse protein compositions obtained by or obtainable by the methods according to the invention as described herein.

The skilled person will understand that when referring to “pulse protein” in some embodiments, in fact a composition is described, which predominantly, but not exclusively comprises pulse proteins. Residual impurities may be present in such compositions. Such residual impurities may include for instance minerals, sugars, etc.

As used herein, the term pulse proteins preferably refers to a pulse protein extract or a composition comprising (based on dry matter) at least 60 wt %, at least 61 wt %, at least 62 wt %, at least 63 wt %, at least 64 wt %, at least 65 wt %, at least 66 wt %, at least 67 wt %, at least 68 wt %, at least 69 wt %, at least 70 wt % proteins, at least 71 wt %, at least 72 wt %, at least 73 wt %, at least 74 wt %, at least 75 wt %, at least 76 wt %, at least 77 wt %, at least 78 wt %, at least 79 wt %, preferably at least 80 wt % proteins, preferably at least 81 wt % proteins, preferably at least 82 wt % proteins, preferably at least 83 wt % proteins, preferably at least 84 wt % proteins, more preferably at least 85 wt % at least 86 wt %, at least 87 wt %, at least 88 wt %, at least 88 wt %, at least 89 wt %, at least 90 wt %, at least 91 wt %, at least 92 wt %, at least 93 wt %, at least 94wt %, at least 95 wt %, at least 96 wt %, at least 97%, at least 98 wt %, at least 99 wt %, at least 99 wt %. Preferably, the term pulse proteins refers to a composition comprising (based on dry matter) from 70 wt % to 98 wt % of proteins, preferably from 80 wt % to 98 wt % of proteins, more preferably from 85 wt % to 98 wt % of proteins, more preferably from 88 wt % to 98 wt % of proteins.

According to the invention, the pulse protein composition has a nitrogen solubility index at a pH ranging from 4.5 to 5.5 of at most 20%, preferably of at most 15%, and at a pH of (at most) 3.5 of at least 20%, preferably of at least 25%, preferably of at least 30%, preferably of at least 35%, preferably of at least 36%, preferably of at least 37%, preferably of at least 38%, preferably of at least 39%, preferably of at least 40%, as measured on a aqueous composition comprising 3 wt % of said pulse protein composition based on the total weight of the aqueous composition.

According to the invention, the pulse protein composition has a nitrogen solubility index at a pH ranging from 4.5 to 5.5 of at most 20%, ranging from 4.5 to 5.25, ranging from 4.5 to 5.0, ranging from 4.5 to 4.75, ranging from 4.75 to 5.5, ranging from 4.75 to 5.25, ranging from 4.75 to 5.0, ranging from 5.0 to 5.5, ranging from 5.0 to 5.25, ranging from 5.25 to 5.5 of less than or at most 20% and the pulse protein composition has a nitrogen solubility index at pH 3.5 of at least 20%, at pH 3.4, at pH 3.3, at pH 3.2, at pH 3.1, at pH 3.0, at pH 2.9, at pH 2.8, at pH 2.7, at pH 2.6, at pH 2.5, at pH 2.4, at pH 2.3, at pH 2.2, at pH 2.1, at pH 2.0, at pH 1.9, at pH 1.8, at pH 1.7, at pH 1.6, at pH 1.5, at pH 1.4, at pH 1.3, at pH 1.2, at pH 1.1, at pH 1.0, at pH 0.9, at pH 0.8, at pH 0.7, at pH 0.6, at pH 0.5, at pH 0.4, at pH 0.3, at pH 0.2, at pH 0.1, at pH 0.0 of at least or more than 20%.

According to an embodiment of the invention, the pulse protein composition has a nitrogen solubility index at a pH ranging from 4.5 to 5.5 of less than 20% (such as between 2% and 20%), preferably at most 15% (such as between 2% and 15%) or at most 10% (such as between 2% and 10%) at a pH of 5.0, and a nitrogen solubility index at a pH ranging from 3.5 to 4.0 of more than 20% (such as between 20% and 80% or between 20% and 70%), preferably at least 25% (such as between 25% and 80% or between 25% and 70%), more preferably at least 30% (such as between 30% and 80% or between 30% and 70%), such as at least 35% (such as between 35% and 80% or between 35% and 70%) or at least 40% (such as between 40% and 80% or between 40% and 70%).

In an embodiment, the pulse protein composition has a nitrogen solubility index at a pH ranging from 4.5 to 5.5 of less than 20% (such as between 2% and 20%), preferably at most 15% (such as between 2% and 15%) or at most 10% (such as between 2% and 10%) at a pH of 5.0, and a nitrogen solubility index at a pH ranging from 3.5 to 4.0 of more than 20% (such as between 20% and 80% or between 20% and 70%), preferably at least 25% (such as between 25% and 80% or between 25% and 70%), more preferably at least 30% (such as between 30% and 80% or between 30% and 70%), such as at least 35% (such as between 35% and 80% or between 35% and 70%) or at least 40% (such as between 40% and 80% or between 40% and 70%), and a nitrogen solubility index of at least 25% (such as between 25% and 99% or between 25% and 98%) at a pH ranging from 6.0 to 8.0, preferably at least 30% (such as between 30% and 99% or between 30% and 98%), more preferably at least 35% (such as between 35% and 99% or between 35% and 98%), most preferably at least 40% (such as between 40% and 99% or between 40% and 98%).

In an embodiment, the pulse protein composition has a nitrogen solubility index at a pH of at least 7 (or ranging from 7 to 8) of at least 70%, preferably of at least 71%, at least 72% at least 73%, at least 74%, at least 75%, at least 76%, at least 77%, at least 78%, at least 79%, at least 80% and at most 100%, at most 99%, at most 98%, at most 97%, at most 96%, at most 95%, at most 94%, at most 93%, at most 92%, at most 91%, at most 90%, at most 89%, at most 88%, at most 87%, at most 85%, and the pulse protein composition has a nitrogen solubility index at a pH of at least 7 (or ranging from 7 to 8) ranging from 70% to 100%, 75% to 95%, 77% to 93%, 80% to 90%, 85% to 95%, preferably 80% to 98%.

In an embodiment, the pulse protein composition has a nitrogen solubility index at a pH ranging from 4.5 to 5.5 of less than 20% (such as between 2% and 20%), preferably at most 15% (such as between 2% and 15%) or at most 10% (such as between 2% and 10%) at a pH of 5.0, and a nitrogen solubility index at a pH ranging from 3.5 to 4.0 of more than 20% (such as between 20% and 80% or between 20% and 70%), preferably at least 25% (such as between 25% and 80% or between 25% and 70%), more preferably at least 30% (such as between 30% and 80% or between 30% and 70%), such as at least 35% (such as between 35% and 80% or between 35% and 70%) or at least 40% (such as between 40% and 80% or between 40% and 70%), and a nitrogen solubility index of at least 25% (such as between 25% and 99% or between 25% and 98%) at a pH ranging from 6.0 to 8.0, preferably at least 30% (such as between 30% and 99% or between 30% and 98%), more preferably at least 35% (such as between 35% and 99% or between 35% and 98%), most preferably at least 40% (such as between 40% and 99% or between 40% and 98%), and a nitrogen solubility index at a pH of at least 7.0 of at least 70%, at least 75% at least 80% and at most 100%, preferably at most 95%.

In an embodiment; the pulse protein composition has an enthalpy of at least 4.5 (ΔH J/g), preferably of at least 5.5 J/g measured by DSC (Differential scanning calorimetry), of at least 7.0 J/g, of at least 4.5 J/g and at most 10 J/g, of at least 5.5 J/g and at most 10 J/g.

According to an embodiment of the invention, the pulse protein composition has a viscosity of at most 2000 cP at pH 6.5, preferably of at most 1900 cP, preferably of at most 1800 cP, preferably of at most 1700 cP, more preferably of at most 1600 cP. According to an embodiment of the invention, the pulse protein composition has a viscosity of at least 10 cP at pH 6.5, preferably of at least 20 cP, preferably of at least 30 cP, more preferably of at least 50 cP. According to an embodiment of the invention, the pulse protein composition has a viscosity of at most 2000 cP at pH 6.5, preferably of at most 1900 cP, preferably of at most 1800 cP, preferably of at most 1700 cP, more preferably of at most 1600 cP; and the pulse protein composition has a viscosity of at least 10 cP at pH 6.5, preferably of at least 20 cP, preferably of at least 30 cP, more preferably of at least 50 cP.

In a further aspect, the invention relates to pulse protein composition having a sodium content of at most 1 wt % based on dry matter, preferably of at most 0.7 wt % based on dry matter, preferably ranging from 0.5 wt % to 0.8 wt %, more preferably ranging from 0.6 wt % to 0.7 wt % based on dry matter.

In a further aspect, the invention relates to pulse protein composition having an emulsion capacity of at least 600g oil/g protein, preferably of at least 700g oil/g protein, preferably ranging from 600 to 800g oil/g protein, more preferably ranging from 650 to 750g oil/g protein.

In a further aspect, the invention relates to pulse protein composition having a gel strength of at most 150 g, preferably of at most 130 g, preferably ranging from 50 g to 150 g, more preferably ranging from 80 g to 130 g.

A second aspect of this invention is a method for preparing a pulse protein composition, such as for instance described in the first aspect of this invention, comprising the following steps:

(a) coarsely grinding pulses so as to obtain coarsely ground pulses;

(b) bringing coarsely ground pulses into contact with an aqueous solution in order to form an aqueous composition comprising coarsely ground pulses;

(c) leaving the coarsely ground pulses to hydrate in said aqueous composition thereby obtaining hydrated coarsely ground pulses;

(d) removing aqueous solution from the aqueous composition comprising hydrated coarsely ground pulses;

(e) wet milling said hydrated coarsely ground pulses; thereby obtaining milled pulses;

(f) fractionating said milled pulses so as to obtain pulse protein composition.

As used herein, “preparing a pulse protein composition” refers to liberating and separating pulse proteins from other constituents of pulses. Extraction of pulse proteins according to certain embodiments of the invention may encompass isolation or purification of pulse proteins. The skilled person will understand that pulse protein extracts do not entirely consist of proteins, and that a certain amount of additional components (impurities) may be present in pulse protein extracts, such as lipids, carbohydrates, sugars, minerals, etc.

According to the invention, steps (a) to (f) of the method as specified above are preferably performed in the following order, i.e. step (a) precedes step (b), which in its turn precedes step (c), which in its turn precedes step (d), which in its turn precedes step (e), which in its turn precedes step (f). However, it is also possible according to the invention that steps (e) and (f) are performed simultaneously, i.e. that the milling step and fractionation step are performed simultaneously.

In step (a) of the method as described herein, pulse is subjected to coarsely grinding. According to the invention, the pulses which are coarsely ground in step (a) are unmilled pulses (i.e. whole pulses). The pulses may however in an embodiment be split pulses. In an embodiment, the pulses are round when harvested and dry. After the hull is removed, the natural split in the seed's cotyledon can be manually or mechanically separated, resulting in “split pulses”.

In a preferred embodiment, the pulses, before step (a), are naturally harvested dry, or in an embodiment the pulses can be fresh pulses. Preferably the pulses are dry pulses, and have a dry matter content (on weight basis) of at least 80% (i.e. at least 80 g of dry matter per 100 g of total weight of the dry pulses), more preferably of at least 85%, for example of at least 90%, for example of at least 95%, such as for instance ranging from 80% to 95%, for example from 85% to 95%, for example from 90% to 95%.

As used herein, the term “coarsely grinding” or equivalent “crushing” has its ordinary meaning in the art. By means of further guidance, coarsely grinding, as used herein may refer to the process of grinding of solid matters, i.e. pulses, under exposure of mechanical forces that trench the structure by overcoming of the interior bonding forces, as for example a crusher, more preferably a breaker from Avimat 1006667 or a crusher Milly. Coarsely grinding may thus disintegrate the native structure of the pulses and gave some blocks mostly without the presence of fines particles. In a preferred embodiment, coarsely ground pulses have been ground dry. In a preferred embodiment, at most 25% of coarsely ground pulses in step (a) have a diameter equal or less than 500 μm, preferably at most 24%, at most 23%, at most 22%, at most 21%, at most 20%, at most 19%, at most 18%, at most 17%, at most 16%, at most 15%, of coarsely ground pulses in step (a) have a diameter equal or less than 500 μm, and 10 to 50%, 15% to 45%, 20% to 40%, of coarsely ground pulses in step (a) have a diameter equal or more than 2 mm, more preferably 15 to 45% of coarsely ground pulses in step (a) have a diameter equal or more than 2 mm.

In a preferred embodiment, the coarsely ground pulses particle size (comprising at least 25% dry matter) have a D10 of at most 1200 μm, preferably of at most 1100 μm, for example at most 1000 μm and at least 800 μm, preferably at least 850 μm, with D10 being defined as the particle size for which ten percent by volume of the particles have a size lower than the D10; and preferably D10 being measured by vibrating screens.

These diameter values are determined from the particle size distribution values of the sample under consideration. This particle size distribution can be expressed as % by weight of particles retained on Alpine vibrating screens having specific meshes, the screen being equipped with a suction device and a manometer for verifying the operating pressure. For this, 7 screens of mesh 100 μm, 200 μm, 300 μm, 400 μm, 1000 μm, 1400 μm and 2000 μm are used, the weight of the fraction of particles retained on each screen is determined by weighing on a laboratory balance and the oversize is expressed as percentage by mass of products as such.

In an embodiment, after grinding the pulses in step (b) of the method according to the invention as described above, an aqueous solution, preferably water, such as tap water, or treated well water, preferably drinking water, i.e. water suitable for human consumption, is added to the pulses. In a further embodiment, an amount of aqueous solution is added to the coarsely ground pulses such as to obtain an aqueous composition comprising the coarsely ground pulses, preferably wherein said composition comprises from 15% to 35% dry matter based on the total weight of the composition, preferably comprising from 15% to 35%, preferably from 20% to 30%, such as at least 19%, such as at least 20%, such as at least 21%, such as at least 22%, for example at least 23%, for example at least 24%, for example at least 25%, for example at least 26%, for example at least 27%, for example at least 28%, for example at least 29%, for example at most 30%, for example at most 35% dry matter based on the total weight of the composition.

As used herein, the term “aqueous composition comprising coarsely ground pulses” used in step (b) refers to a composition mainly comprising or exclusively consisting of an aqueous solution such as water, apart from the coarsely ground pulses. In some embodiments, the aqueous composition for instance comprises a suspension of coarsely ground pulses in an aqueous solution. In a preferred embodiment, the aqueous solution is water. In an embodiment, the water can be tap water, or well water which has been treated so as to render it drinkable. The water used is preferably drinking water, i.e. water suitable for human consumption. According to an embodiment, hence also bacteria can be present.

In an embodiment, the aqueous composition comprising the coarsely ground pulses is subjected to hydration in step (c) of the above described method at a pH of at least 4.0, preferably at least 4.5, for example at least 5.0, as measured on the aqueous composition comprising the coarsely ground pulses, after said composition had been coarsely milled.

In an embodiment, the aqueous composition comprising coarsely ground pulses is subjected to hydration in step (c) of the above described method for a duration of at least 5 minutes, preferably at least 30 minutes, more preferably at least 75 minutes. In another embodiment, the aqueous composition comprising coarsely ground pulses is subjected to hydration in step (c) of the above described method for a duration ranging from 15 minutes to 4 h, preferably ranging from 30 minutes to 4 h, more preferably ranging from 30 minutes to 3 h, such as for instance at least 45 minutes, for example at least 60 minutes, for example at least 75 minutes, for example at least 90 minutes, for example at least 105 minutes, about 75 minutes, about 30 minutes, about 60 minutes, about 2 h, for example at most 4 h, for example at most 4 h.

In a further embodiment, the aqueous composition comprising coarsely ground pulses is subjected to hydration in step (c) of the above described method at a temperature of at least 4° C., for example ranging from 4° C. to 50° C., preferably ranging from 20° C. to 40° C. In another embodiment, the aqueous composition comprising coarsely ground pulses is subjected to hydration in step (c) of the above described method at a temperature ranging from 15° C. to 30° C., from 20° C. to 30° C., or from 20° C. to 25° C., preferably 20° C., or about 20° C., or room temperature.

In a preferred embodiment, the coarsely ground pulses are bringing into contact with an aqueous solution at a ratio aqueous solution/coarsely ground pulse ranging from 15/1 to 5/1, preferably from 10/1 to 8/1.

As used herein, the term “fermentation” has its ordinary meaning in the art. By means of further guidance, fermentation is a microbiological metabolic process comprising conversion of sugar to acids, and/or gases using yeast and/or bacteria. Subjecting an aqueous composition comprising coarsely ground pulses to fermentation as used herein therefore may refer to incubating the aqueous composition comprising coarsely ground pulses with bacteria and/or yeast under conditions suitable for the bacteria and/or yeast to be metabolically active.

In an embodiment, the aqueous composition comprising coarsely ground pulses is subjected to fermentation in step (c) of the above described method with lactic acid bacteria.

As used herein, “lactic acid bacteria” refers to a population of Gram-positive, low-GC, acid-tolerant, generally non-sporulating, non-respiring rod or cocci that are associated by their common metabolic and physiological characteristics, and produce lactic acid as the major metabolic end product of carbohydrate fermentation. These bacteria, can be usually found in decomposing plants and lactic products. As used herein, lactic acid bacteria may be non-pathogenic in the sense that they do not cause harm or does not lead to deleterious effects when ingested. Preferably, the lactic acid bacteria as used herein are one or more bacterial genera selected from Lactobacillus, Pediococcus, Lactococcus, Leuconostoc, Streptococcus, Aerococcus, Carnobacterium, Enterococcus, Oenococcus, Sporolactobacillus, Tetragenococcus, Vagococcus, and Weisella, and combinations thereof. Most preferably, the lactic acid bacteria are Lactobacillus sp, most preferably selected from the group consisting of Lactobacillus fermentum, Lactobacillus crispatus, Lactobacillus panis, Lactobacillus mucosae, Lactobacillus pontis, Lactobacillus acidophilus, Lactobacillus plantarum, Lactobacillus helveticus, Lactobacillus buchneri, Lactobacillus delbrueckii, and Lactobacillus casei, and mixtures thereof, for example from the group consisting of Lactobacillus fermentum, Lactobacillus crispatus, Lactobacillus panis, Lactobacillus mucosae, Lactobacillus pontis, Lactobacillus acidophilus and mixtures thereof, for example from the group consisting of Lactobacillus fermentum, Lactobacillus crispatus, Lactobacillus panis, Lactobacillus mucosae, Lactobacillus pontis, and mixtures thereof, for example said bacteria is Lactobacillus fermentum, or Lactobacillus crispatus. In some embodiments, fermentation may be spontaneous fermentation (i.e. in which no fermenting microorganisms are deliberately added, but fermentation is effected by microorganisms which naturally occur on/in pulses and/or in the environment) or may be inoculated fermentation (i.e. in which fermenting microorganisms are deliberately added). Fermentation may also be effected by transferring part or all of the aqueous fraction of one fermentation step to a next fermentation which is to be started up, for example by transferring at least 1/10th of the first fermentation volume to at least one second fermentation step. In a preferred embodiment, the fermentation is anaerobic fermentation.

In an embodiment, the aqueous composition comprising pulses is subjected to fermentation in step (c) of the above described method until the pH in the pulses is at most 5.5, preferably at most 5.0, more preferably ranging from 3.5 to 5, preferably, as measured at room temperature on 1 g of said pulses which have been milled and then suspended in 9 g of water, as described in the experimental section. In an embodiment, the aqueous composition comprising pulses is subjected to fermentation in step (c) of the above described method until the pH in the pulses ranges from 3.5 to 4.5, for example from 4.0 to 5.0, preferably from 4.5 to 5.5, such as for instance at least 3.5, for example at least 3.75, for example at least 4.0, for example at least 4.25, for example at least 4.50, for example at least 4.75, for example at most 5.0, for example at most 5.25, for example at most 5.5, preferably, as measured at room temperature on 1 g of said pulses which have been milled and then suspended in 9 g of water, as described in the experimental section.

In an embodiment, the dry pulses have a pH of at least 6.0, preferably ranging from 6.0 to 7.1 before fermentation in step (c) of the above described method, such as for instance at least 6.0, for example at least 6.1, for example at least 6.2, for example at least 6.3, for example 6.4, for example 6.5, for example 6.6, for example 6.7, for example 6.8, for example 6.9, for example 7.1, preferably ranging from 6.25 to 6.75, preferably as measured at room temperature on 5 g of dry pulses which have been milled with 95 g of water.

In an embodiment, the aqueous composition comprising pulses is subjected to fermentation in step (c) of the above described method until the pH in the pulses lowers by at least 1 pH unit, preferably by at least 1.5 pH unit, such as for instance at least 1, for example at least 1.1, for example at least 1.2, for example at least 1.3, for example at least 1.4, for example at least 1.5, for example at least 1.6, for example at least 1.7, for example at least 1.8, for example at least 1.9, for example at least 2, for example at least 2.1, for example at least 2.2, for example at least 2.3, for example at least 2.4, for example at least 2.5, for example at least 2.6, for example at least 2.7, for example at least 2.8, for example at least 2.9, for example at least 3 pH unit, preferably, as measured at room temperature on 1 g of said pulses which have been milled and then suspended in 9 g of water. In another embodiment, the aqueous composition comprising pulses is subjected to fermentation in step (c) of the above described method until the pH in the pulses lowers by 1 pH unit to 3 pH units, preferably by 1.5 pH units to 3 pH units, such as for instance by 1.5 pH units to 2.5 pH units, for example by 2.0 pH units to 3.0 pH units, preferably, as measured at room temperature on 1 g of said pulses which have been milled and then suspended in 9 g of water. By means of example, and without limitation, at the start of fermentation, the pH in the pulses may be 6.5, and at the end of fermentation, the pH in the pulses may be 5.0, preferably, as measured at room temperature on 1 g of said pulses which have been milled and then suspended in 9 g of water, as described in the experimental section.

In an embodiment, the aqueous composition comprising pulses is subjected to fermentation in step (c) of the above described method in the presence of fermenting microorganisms, such as bacteria and/or yeast, preferably comprising one or more lactic acid bacteria, wherein preferably said fermenting lactic acid bacteria are selected from the group comprising one or more Lactobacillus sp. In an embodiment, the fermentation is performed in the presence of one or more of the above specified microorganisms, preferably lactic acid bacteria, at a concentration ranging from 10² cfu/ml to 10¹⁰ cfu/ml of said aqueous composition comprising the pulses, such as at least 10² cfu/ml, for example at least 10⁵ cfu/ml, for example at least 10⁶ cfu/ml, for example at least 10⁷ cfu/ml, for example at least 10⁸ cfu/ml, for example at least 10⁹ cfu/ml of said aqueous composition comprising the pulses. “cfu” (colony forming units) are well known in the art and can for instance be determined by plate counting. It is to be understood that “cfu/ml” refers to the amount of cfu per ml of the total aqueous composition comprising pulses, i.e. including the pulses.

In another embodiment, the aqueous composition comprising the pulses is subjected to fermentation in step (c) of the above described method in the presence of fermenting microorganisms, preferably comprising one or more lactic acid bacteria, preferably comprising one or more Lactobacillus sp., wherein the microorganisms, preferably lactic acid bacteria, are added at a concentration of at least 10² cfu/ml of aqueous composition comprising pulses.

In an embodiment, the pulses at step (d) of the above described method, i.e. at the end of hydration and before the milling step, have a dry matter content (on weight basis) ranging from 35% to 60%, preferably from 35% to 55%, for example from 40% to 50%, such as for instance at least 40%, for example at least 41%, at least 42%, for example at least 43%, for example at least 44%, for example at least 45%, for example at least 46%, for example at least 47%, about 48%, about 49%, for example at most 50%, for example at most 55%, for example at most 60% based on the total weight of the pulses at the end of the hydration, i.e. after the pulses have been isolated from the aqueous composition.

In step (d), the hydrated coarsely ground pulses are removed from the aqueous composition after step (c) and then subjected to milling.

Preferably, the pulses are washed or rinsed after step (d) and before step (e). Washing or rinsing may be performed with an aqueous solution, preferably water, such as tap water, or treated well water, preferably drinking water, i.e. water suitable for human consumption.

In step (e) of the method according to the invention as described above, the pulses which have been subjected to hydration in step (c) and wherein the aqueous solution has been removed in step (d), at least 90% water removed, at least 80% water removed, at least 70% water removed, at least 60% water removed, at least 50% water removed, are milled.

As used herein, the term “milling” has its ordinary meaning in the art. By means of further guidance, milling, as used herein may refer to the process of grinding of solid matters, i.e. pulses, under exposure of mechanical forces that trench the structure by overcoming of the interior bonding forces. Milling may thus disintegrate the native structure of the pulses. In a preferred embodiment, the milled particle size of a milled pulse comprises at least 25% (on dry matter) have a D50 of at most 300 μm, preferably of at most 250 μm, for example at most 200 μm, with D50 being defined as the particle size for which fifty percent by volume of the particles have a size lower than the D50; and D50 being preferably measured by laser diffraction analysis on a Malvern type analyzer.

For example, the D50 can be measured by sieving or by laser diffraction analysis. For example, Malvern Instruments' laser diffraction systems may advantageously be used. The particle size may be measured by laser diffraction analysis on a Malvern type analyzer. The particle size may be measured by laser diffraction analysis on a Malvern type analyzer after the pulses have been milled and are in a water suspension having a 25% dry matter. Suitable Malvern systems include the Malvern 2000, Malvern MasterSizer 2000 (such as Mastersizer S), Malvern 2600 and Malvern 3600 series. Such instruments together with their operating manual meet or even exceed the requirements set-out within the ISO 13320 Standard. The Malvern MasterSizer (such as Mastersizer S) may also be useful as it can more accurately measure the D50 towards the lower end of the range e.g. for average particle sizes of less 8 μm, by applying the theory of Mie, using appropriate optical means.

In an embodiment, prior to, during, or after milling the pulses in step (e) of the method according to the invention as described above, an aqueous solution, preferably water, such as tap water, or treated well water, preferably drinking water, i.e. water suitable for human consumption, is added to the pulses. In a further embodiment, an amount of aqueous solution is added to the pulses such as to obtain an aqueous composition comprising the milled pulses, preferably wherein said composition comprises from 10% to 35% dry matter based on the total weight of the composition, preferably comprising from 10% to 35%, preferably from 20% to 30%, such as at least 19%, such as at least 20%, such as at least 21%, such as at least 22%, for example at least 23%, for example at least 24%, for example at least 25%, for example at least 26%, for example at least 27%, for example at least 28%, for example at least 29%, for example at most 30%, for example at most 35% dry matter based on the total weight of the composition. In a preferred embodiment, the milling process is a wet milling process, such that an aqueous solution is added to the pulses prior to or during milling.

In an embodiment, step (f) of the method according to the invention as described above, comprises fractionating said milled pulses in a fraction comprising at least 50 wt % of protein based on the total dry matter of said fraction. As used herein, the term “fractionating” refers to a process by which at least part of the proteins comprised in the pulses are separated from the rest of the pulse. It is to be understood that when referring to the fractionation step, in some embodiments not all, but nevertheless the majority of individual proteins are separated, such as preferably at least 50 wt %, preferably at least 60 wt % of the proteins, based on the total protein content of the milled pulses, are separated.

Fractionation of the milled pulses into a pulse protein composition may be achieved by any means known in the art such as adding a suitable base, or a salt. Preferably, the milled pulses are fractionated by increasing the pH of the milled pulses.

Preferably fractionation step (f) comprises adjusting the pH of the milled pulses to a pH of at least 6, preferably at least 7, most preferably a pH of at least 8 and at most 9. Preferably fractionation step (f) comprises increasing the pH of an aqueous composition comprising the milled pulses. In a preferred embodiment, the pH of the composition is adjusted to a pH of at least 6, more preferably at least 7. In another preferred embodiment, the pH of the composition is adjusted to a value ranging from pH 6 to pH 9, more preferably from pH 7 to pH 9, such as at least 7.0, for example at least 7.1, for example at least 7.2, for example at least 7.3, for example at least 7.4, for example at least 7.5, for example at least 7.6, for example at least 7.7, for example at least 7.8, for example at least 7.9, for example at least 8.0, for example at least 8.1, for example at least 8.2, for example at least 8.3, for example at least 8.4, for example at most 8.5, for example at most 8.6, for example at most 8.7, for example at most 8.8, for example at most 8.9, for example at most 9.0, most preferably ranging from pH 7.5 to pH 8.5, most preferably pH 8 or about pH 8. Preferably, this pH adjustment is performed on an aqueous composition comprising milled pulses having a dry matter of at most 45%, preferably at most 40%, preferably at most 35%, preferably at most 30%, preferably at most 25%. In an embodiment, the dry matter content of the milled pulses is adjusted to the above cited dry matter content by addition of water accordingly. This pH adjustment can be performed using any suitable base, such as sodium hydroxide, calcium hydroxide, potassium hydroxide and the like. In a preferred embodiment, the pH of the milled pulse containing compositions is adjusted by addition of sodium hydroxide.

In a preferred embodiment, after adjustment of the pH the pulse protein composition is separated from the aqueous composition comprising milled pulses, by decantation or by the use of a hydrocyclone, preferably by decantation, preferably centrifugal decantation (i.e. by means of a decanting centrifuge), wherein the pulse protein composition is the supernatant, and the pellet is a fraction comprising among others the rest of the content of the milled pulses and some residual proteins. In an embodiment, more than one fractionation step may be performed sequentially. For instance, after decantation, the pellet may be suspended in an aqueous solution (preferably in an aqueous solution, preferably having a pH similar or higher (preferably pH 8.5 or about pH 8.5) than in the first fractionation step) and subjected to a decantation step, such as to retrieve additional proteins in the supernatant.

As indicated elsewhere, step (e) and step (f) of the method according to the invention may be performed simultaneously or in the alternative, step (f) may be performed subsequently to step (e).

In another embodiment, the pulse protein composition comprises from 1.0% to 40% dry matter, preferably from 2.0% to 30% dry matter, more preferably from 3.0% to 20% dry matter, more preferably from 3.0% to 15% dry matter, such as from 3.0% to 10%.

In an embodiment, the dry matter of the pulse protein composition comprises at least 50 wt % pulse proteins, preferably at least 60 wt % pulse proteins, more preferably at least 65 wt % pulse proteins, such as for instance at least 70 wt %, such as from at least 55 wt % and at most 80 wt %, or ranging from 60 wt % to 80 wt %, or ranging from 60 wt % to 78 wt %.

Optionally, but preferably, the protein composition is further subjected to at least one heat treatment, preferably a heat treatment at a temperature of at least 50° C., preferably at least 60° C., more preferably at least 70° C., yet more preferably at least 80° C., yet more preferably at least 90° C., for example at least 95° C., preferably at most 150° C. For example said heat treatment can be ranging from 70° C. to 110° C., preferably ranging from 70° C. to 150° C., more preferably ranging from 100° C. to 130° C. The heat treatment may advantageously be effected by means of one or more heat exchangers or by direct or indirect injection of steam. In an embodiment, the duration of the heat treatment is of at least 0.02 second, preferably ranging from 0.02 second to 20 min, preferably ranging from 10 seconds to 10 minutes. The skilled person will appreciate that the higher the temperature, the shorter the duration of heat treatment. For instance, the heat treatment may be at a temperature ranging from 65° C. to 150° C. for a time ranging from 0.02 s to 20 s. Alternatively, for instance, the heat treatment may be at a temperature ranging from 95° C. to 115° C. for a time ranging from 15 s to 5 min. Alternatively, for instance, the heat treatment may be at a temperature ranging from 70° C. to 100° C. for a time ranging from 5 min to 15 s. In a preferred embodiment, the heat treatment is performed at a temperature ranging from 95° C. to 110° C. for a time ranging from 2 min to 8 min. In another preferred embodiment, the heat treatment is performed at a temperature ranging from 110° C. to 140° C. for a time ranging from 1 s to 8 s. After the heat treatment, the pulse protein composition may be maintained at a temperature ranging from 70° C. to 90° C., preferably ranging from 70° C. to 85° C., before drying.

In a further additional step, the pulse protein composition may be subjected to drying, whether or not previously subjected to heat treatment after isolation. Drying may be effected by any means in the art, such as by application of hot air, evaporation, freeze drying, contact drying, steam drying, dielectric drying, roller drying, flash drying, etc. In a preferred embodiment, the proteins are dried by spray drying. Optionally, the pulse protein composition may be subjected to granulation, by techniques known in the art.

The overall yield is the ratio (expressed in %) between the mass of dry protein composition and the mass of dry dehulled faba beans

yield (%)=100×m(dry protein composition)/m(dehulled beans)

The overall yield is ranging from 10 to 30%, preferably ranging from 15 to 30%, more preferably ranging from 20 to 30%.

In a preferred embodiment, the present invention relates to a method for extracting pulse proteins, comprising the steps of:

(i) coarsely grinding pulses comprising dry and dehulled pulses so as to obtain coarsely ground pulses;

(ii) bringing coarsely ground pulses into contact with an aqueous solution in order to form an aqueous composition comprising coarsely ground pulses;

(ii) leaving the coarsely ground pulses to hydrate in said aqueous composition thereby obtaining hydrated coarsely ground pulses for at least 15 minutes and at most 4 h;

(iv) removing aqueous solution from the aqueous composition comprising hydrated coarsely ground pulses;

(v) wet milling said hydrated coarsely ground pulses; thereby obtaining milled pulses;

(vi) fractionating said milled pulses so as to obtain at least pulse protein composition, optionally simultaneously with step (v), by adjusting the pH of the milled pulses to a pH of at least 6.0, for example ranging from 6.0 to 9, preferably from 7 to 9.

In a preferred embodiment, the present invention relates to a method for extracting pulse protein, comprising the steps of:

(i) coarsely grinding pulse comprising dry and dehulled pulse wherein said dry dehulled pulse have dry matter content of 80% to 95% based on total weight of the dry dehulled pulse so as to obtain coarsely ground pulses where at most 25% of coarsely ground pulses in step (a) have a diameter equal or less than 500 μm, preferably at most 20% of coarsely ground pulses in step (a) have a diameter equal or less than 500 μm, more preferably at most 15% of coarsely ground pulses in step (a) have a diameter equal or less than 500 μm and 10 to 50% of coarsely ground pulses in step (a) have a diameter equal or more than 2 mm, more preferably 25 to 40% of coarsely ground pulses in step (a) have a diameter equal or more than 2 mm.

(ii) bringing coarsely ground pulse into contact with an aqueous solution in order to form an aqueous composition comprising coarsely ground pulse;

(iii) leaving the coarsely ground pulse to hydrate in said aqueous composition thereby obtaining hydrated coarsely ground pulse for at least 15 minutes and at most 4 h;

(iv) removing aqueous solution from the aqueous composition comprising hydrated coarsely ground pulse;

(v) wet milling said hydrated coarsely ground pulse; thereby obtaining milled pulse;

(vi) fractionating said milled pulse so as to obtain at least pulse protein composition, optionally simultaneously with step (v), by adjusting the pH of said milled pulse to a pH of at least 6.0, for example ranging from 6.0 to 9.0, preferably from 7.0 to 9.0.

In a preferred embodiment, the present invention relates to a method for extracting faba bean protein, comprising the steps of:

(i) coarsely grinding faba bean comprising dry and dehulled faba bean wherein said dry dehulled faba bean have dry matter content of 80% to 95% based on total weight of the dry dehulled faba bean so as to obtain coarsely ground faba bean where at most 25% of coarsely ground faba bean in step (a) have a diameter equal or less than 500 μm, preferably at most 20% of coarsely ground faba bean in step (a) have a diameter equal or less than 500 μm, more preferably at most 15% of coarsely ground faba bean in step (a) have a diameter equal or less than 500 μm and 10 to 50% of coarsely ground faba bean in step (a) have a diameter equal or more than 2 mm, more preferably 25 to 40% of coarsely ground faba bean in step (a) have a diameter equal or more than 2 mm.;

(ii) bringing coarsely ground faba bean into contact with an aqueous solution in order to form an aqueous composition comprising coarsely ground faba bean where the pH in said faba bean is ranging from 3.5 to 7.0, as measured at room temperature on 1 g of said faba bean which have been milled and then suspended in 9 g of water, preferably wherein the pH in the dry faba bean is at least 6.5, as measured at room temperature on 5 g of dry faba bean which have been milled with 95 g of water;

(iii) leaving the coarsely ground faba bean to hydrate in said aqueous composition thereby obtaining hydrated coarsely ground faba bean for at least 15 minutes and at most 4 h at a temperature ranging from 4° C. to 50° C.;

(iv) removing aqueous solution from the aqueous composition comprising hydrated coarsely ground faba bean;

(v) wet milling said hydrated coarsely ground faba bean; thereby obtaining milled faba bean;

(vi) fractionating said milled faba bean so as to obtain at least faba bean protein composition, optionally simultaneously with step (v), by adjusting the pH of said milled faba bean to a pH of at least 6.0, for example ranging from 6.0 to 9.0, preferably from 7.0 to 9.0.

In a further aspect, the present invention relates to a composition comprising pulse proteins composition obtained by or obtainable by the methods according to the invention as described herein. In a preferred embodiment, the edible composition comprised from 1 wt % to 90 wt % of the pulse proteins composition, at least 5 wt %, at least 10 wt %, at least 20 wt %, at least 30 wt % and at most 90 wt %, at most 80 wt %, or at most 70 wt %.

In a preferred embodiment, such composition is an edible composition. Preferably said composition is a food or feed, more preferably a dairy product, confectionary product, beverage, acidic beverage, meat product, vegetarian product, food supplement, nutritional product destined to weight control, sports, medical food and food for elderly, and a bakery food product. In a preferred embodiment, said food product is a biscuit, bread, cake, waffle, or fudge.

Accordingly, in a further aspect, the present invention relates to the use of the pulse proteins as described herein, in particular the pulse proteins obtained or obtainable according to the methods as described herein, in food or feed products. In a preferred embodiment, the food products are selected from the group comprising dairy products, confectionary products, beverages, meat products, vegetarian products, food supplements, nutritional products destined to weight control, sports, medical food and food for elderly, and bakery food products. In a preferred embodiment, the food products are bakery food products or confectionery food products. The pulse proteins as described herein may for instance partially or completely replace other proteins in food or feed products, such as for instance proteins of animal origin, such as dairy proteins.

Particularly suited applications of the pulse proteins as described herein may for instance involve applications in which the Maillard reaction is involved, i.e. browning or glazing reactions, such as typically found in processes for preparing bakery food products or confectionery products.

The aspects and embodiments of the invention are further supported by the following nonlimiting examples. The aspects and embodiments of the invention are further supported by the following non-limiting examples.

### EXAMPLES

### Protocols

Unless otherwise specified, in the examples below, all parameters are measured as defined in this section. The measurement of the parameters as defined in this section also represent in preferred embodiments the method for measuring said parameters according to the invention as indicated in the respective aspects and embodiments of the above detailed description.

### Dry Matter Determination

Total dry matter was determined gravimetrically as residue remaining after drying. Moisture was evaporated from sample by oven drying.

5 g of sample were weighed in a dry aluminum dish previously weighed (precision balance Ohaus, capacity 410 g, sensitivity 0.001 g). The sample was placed in an oven at 103° C. until the residual weight remained constant (at least 24 h). Sample was cooled in a desiccator for 1 h and then immediately weighed. Results are expressed in % (g of dry matter per 100 g of sample).

Dry matter (%)=(m3−m1)/(m2−m1)×100

m1=weight of the dry aluminum dish (in g)

m2=weight of the aluminum dish with the sample before drying (in g)

m3=weight of the aluminum dish with the sample after drying (in g)

### Determination of Protein Content by the Dumas Method

The apparatus (Leco FP2000) was calibrated with EDTA marketed by Leco under reference 502092. The Quantities of EDTA weighed for the realization of the calibration ranged from 0.08 g to 0.50 g (0.08 g, 0.15 g, 0.25 g, 0.35 g, 0.40 g, 0.50 g). 0.3 g to 1 g of sample was weighed on a precision balance (Sartorius BP61S, capacity 61 g, sensitivity 0.1 mg) and placed into a ceramic boat. The ceramic boat was automatically placed in an oven at 1200° C. wherein the sample was burnt in a combustion tube by pyrolysis under controlled oxygen flow. Nitrogen compounds are converted to N₂ and NO, while other volatile decomposition compounds are retained through adsorbent filters and series of purification regents. All nitrogen compounds are reduced to molecular N, which is quantitatively determined by a thermal conductivity detector. The Nitrogen content was then calculated by a microprocessor.

Results are expressed as a percentage of protein (%N*6.25):

% Nitrogen=g of Nitrogen per 100 g of sample (dry matter)

% protein=% Nitrogen×6.25

### Determination of Nitrogen Content in NSI Samples by the Dumas Method

The apparatus (Leco FP2000) was calibrated with a solution of glycine 15 mg/ml (glycine powder marketed by Merck under reference 1.04201.1000). The quantities of the glycine solution 15 mg/ml weighed for the realization of the calibration ranged from 0.1 g to 1.8 g (0.1 g, 0.4 g, 0.7 g, 1.1 g, 1.4 g, 1.8 g). 1 g to 1.8 g of sample was weighed on a precision balance (Sartorius BP61S, capacity 61 g, sensitivity 0.1 mg) and placed into a ceramic boat covered by a nickel insert. The ceramic boat was automatically placed in an oven at 1200° C. wherein the sample was burnt in a combustion tube by pyrolysis under controlled oxygen flow. Nitrogen compounds are converted to N₂ and NO, while other volatile decomposition compounds are retained through adsorbent filters and series of purification regents. All nitrogen compounds are reduced to molecular N, which is quantitatively determined by a thermal conductivity detector. The Nitrogen content was then calculated by a microprocessor.

Results are expressed as a percentage of Nitrogen:

% Nitrogen=g of Nitrogen per 100 g of sample

### Determination of Nitrogen Solubility Index (NSI)

After dispersion of proteins in demineralized water, nitrogen solubility index was determined by measuring the ratio between the percentage of nitrogen in the supernatant after centrifugation and the percentage of nitrogen in the starting suspension. The method was used on a protein extract powder with a dry matter content of 90 to 99% (weight basis) and was done in the month after drying of the protein extract. The measurement was done at room temperature.

9.0 g of sample were introduced in a 400 ml beaker and made up to 300 g (balance Ohaus ARC120, sensitivity 0.01 g, capacity 3100 g) with demineralized water at room temperature. The suspension was homogenized with a spoon and then stirred for 5 minutes on a stirring plate (Stuart US151) at intensity 4. 10 ml of the starting suspension were collected and analyzed for the nitrogen content on a protein analyzer Leco FP 2000. The suspension was split into two beakers of 150 ml, the pH was raised in one and decreased in the other. The pH of the suspension was adjusted to pH 3.5, 4.5, 5.5, 6.5, 7 and 8 with HCl 1N or NaOH 1N (pH-meter WTW pH/Cond 340i/SET). For each pH adjustment, the pH value was recorded once stabilized and 10 ml of the suspension were collected in a 10 ml centrifuge tube. Aliquots of the suspension at different pH were centrifuged 15 min at 6000 rpm (centrifuge ALC 4239 R). The different supernatants were collected and analyzed for the nitrogen content on a protein analyzer Leco FP 2000. For each tested pH, the nitrogen solubility index was calculated according to the following expression:

% Nitrogen solubility index=% Nitrogen in supernatant/% Nitrogen in starting solution×100%

Nitrogen solubility index=% Nitrogen in supernatant/% Nitrogen in starting solution×100

### Determination of Viscosity With the Viscometer Brookfield DVII

The determination of a protein suspension viscosity with a viscometer Brookfield DVII is the measure of its resistance to flow imposed by the rotation of a cylindrical probe. This resistance causes the twist of a spring fixed to the sensor of a drive system. The value of viscosity, expressed in centiPoise (cP), is proportional to the percentage of torsion indicated by the viscometer and to a multiplicative factor depending on the used probe and its rotation speed. The method was used on a protein extract powder with a dry matter content of 90 to 99% (weight basis) and was done in the month after drying of the protein extract. The measurement was done at room temperature.

A suspension of 13.5% proteins (weight basis) was prepared. 75 g of sample were weighed (balance Ohaus ARC120, sensitivity 0.01 g, capacity 3100 g) in a 250 ml beaker and the necessary amount of demineralized water was weighed in a 1 L plastic beaker, both at room temperature. The powder was suspended in water under mechanical stirring (IKA, EURO-ST.P CV) at 700 rpm for 5 minutes with the use a dissolver 80 cm diameter (marketed by Roth under reference A322.1). The pH of the suspension was measured under stirring (pH-meter WTW pH/Cond 340i/SET). The agitation was stopped for 3 minutes and the viscosity of the suspension was measured at three different locations with a viscometer Brookfield DVII+Pro at speed 50 rpm. The probe used for the measure was chosen between SO1 to SO7 such that the percentage of torsion was between 20% and 80%. The viscosity value was recorded after 4 seconds of probe rotation. The suspension was placed again under mechanical stirring for 5 minutes at 700 rpm during which the pH was adjusted to 6.4 with HCl 3N. The agitation was stopped for 3 minutes and the viscosity of the suspension was measured in the same way as previously. Similarly, the viscosity of the suspension was measured at pH 6.2, 6.0 and 5.8 after 5 min of stirring at 700 rpm and 3 minutes of rest. When the initial pH of the suspension at 13.5% of proteins was equal to or below 5.8, the pH was raised to pH 7.5 with NaOH 3N, instead of being decreased with HCl 3N.

### Determination of Na Content

The determination of sodium content is measured by ICP-AES.

The principle of the method is to ionize the sample in inert gas plasma. The atoms become ions by a flame at high temperature. The light emitted from the element is then detected and measured, its intensity compared to that emitted by the same element contained in a sample of known concentration analyzed under the same conditions. The apparatus (ICP-AES-(Inductively Coupled Plasma—Atomic Emission Spectrometry)) is calibrated with sodium chloride marketed by WVR under reference RM002058L5. Weights of sodium chloride for the calibration are adapted for the dosage of the sample. Prepare 2 g of ash from the sample. The ashes are diluted in demineralized water to be in the range of reading of the ICP-AES. The solution is filtered on paper Whatman 595 ½ 185 mm. The sample is ionized by injection to the ICP-AES. The result is expressed in mg/kg raw (i.e. fresh, not dry matter).

### Determination of Emulsion Capacity

A 1 wt % protein solution in distilled water is prepared. The solution is then stirred with a bar magnet for 1 h. During this time, the pH is adjusted to 6.5. In the conical jug, 50 g of solution 1 wt % is weighed. Then the oil is poured into a 600 ml beaker. A peristaltic pump is used to introduce oil little by little in the solution (the speed of the pump is set on 25%) and the ultra-turax (ULTRA TURRAX IKA T digital) speed is adjusted on the speed between 9500 and 13500 rpm. The ultra-turax is placed in the bottom of the conical jug and then the oil arrived above the liquid. The pump and the ultra-turax start at the same time. The conical jug is manually shaken to distribute the oil in the solution. After some time observe the formation of an emulsion is observed: the mixture becomes more thick and whitish. Due to the fact that shaking is still on-going the emulsion will break, that is the solution becomes liquid. (the pump is stopped when the emulsions break (i.e. starts to break))

Re-weigh the beaker containing the oil and calculate the exact amount of oil introduced in the solution.

### Note

For samples with high emulsifying capacity (800-900 g/g) introduce the maximum amount of oil in the jug and record the result in the following way: >X g/g if the emulsion has still not broken arrived at the top of the jug.
Take care to keep the top hole of the ultra-turax on the surface of the emulsion in such way to incorporate the oil on a continuous basis. Occasionally move the jug up and down to have a homogeneous emulsion permanently.
Determine the emulsifying capacity by calculating the quantity of oil (in g) introduced per gram of sample.
Do a second measurement with 50 g of solution 1% remaining.

### Gel Strength Determination

The gel strength was determined by the maximum resistance of a gel to a compression applied by a probe directed by a texture analyzer. The formation of a protein gel consisted of making a protein suspension which was subjected to heat treatment followed by cooling. Gel strength was expressed either in g or N. The method was used on a protein extract powder with a dry matter content of 90 to 99% (weight basis) and was done in the month after drying of the protein extract. The measurement was done at room temperature. A suspension of 13.5% proteins (weight basis) was prepared. 75 g of sample were weighed (balance Ohaus ARC120, sensitivity 0.01 g, capacity 3100 g) in a 250 ml beaker and the necessary amount of demineralized water was weighed in a 1 L plastic beaker, both at room temperature. The powder was suspended in water under mechanical stirring (IKA, EURO-ST.P CV) at 700 rpm for 10 minutes exactly with the use of a dissolver 80 cm diameter (marketed by Roth under reference A322.1). Meanwhile, the pH of the suspension was adjusted to 6.0 with HCl 3N or NaOH 3N according to the initial pH of the suspension (pH-meter WTW pH/Cond 340i/SET). The suspension was poured into two 220 ml glass jars which were placed in a water bath at 80° C. for 1 h. The glass jars were cooled for 10 min in a water bath at room temperature and then placed for 16 h in a cold room at 4° C. The glass jars were placed at room temperature for 15 min so as to bring them to room temperature. The gel strength was measured on a Texture Analyzer TAXT2i (Stable Micro Systems, Ltd) with a Compression load cell of 5 kg and a conical probe 44 (P45C Cone 45° Perspex). The gel strength was the maximum force recorded at the end of the penetration, expressed in g.

### TA-XT2i Settings

Measure force in compression—Hold until time
Pre-test speed: 2 mm/s
Test speed: 1 mm/s
Post test speed: 1 mm/s
Distance of penetration: 35 mm

Trigger type: Auto—3 g
Time: 10 s

### pH Measurement on Aqueous Composition Comprising Pulses or Milled Pulses

pH was measured with a pH meter WTW SERIES Inolab Termil 740. The apparatus was calibrated with buffer solutions at pH 4.01 (WTW pH 4.01 Technical Buffer, Model STP4, Order n° 108706) and pH 7 (WTW pH 7.00 Technical Buffer, Model STP7, Order n° 108708). The pH was measured on the aqueous composition excluding pulses. A sample of aqueous solution was taken directly from the fermentation vessel. The pH of the sample was measured once the value was stabilized.

### pH Measurement On Protein Extract Powder

pH was measured with a pH meter WTW pH/Cond 340i/SET. The apparatus was calibrated with buffer solutions at pH 4.01 (WTW pH 4.01 Technical Buffer, Model STP4, Order n° 108706) and pH 7 (WTW pH 7.00 Technical Buffer, Model STP7, Order n° 108708). 5.0 g of protein extract powder were introduced in a 100 ml beaker and made up to 50 g (balance Ohaus ARC120, sensitivity 0.01 g, capacity 3100 g) with demineralized water at room temperature. The suspension was stirred for 5 minutes on a stirring plate (Stuart US151) at intensity 4. The pH of the suspension was measured (at room temperature) under stirring once the value was stabilized.

### Determination of the Diameter of Coarsely Ground Pulse

Diameter is determined according to the vibrating sieves method, using Retsch AS 200 control.

Diameter of the sieves used: 2000 μm, 1400 μm, 1000 μm, 500 μm, 400 μm, 315 μm, 200 μm, 100 μm

The clean and dry sieve is weighed and stacked. 50 g of powder to analyze is weighed and placed on the upper sieve. A cover on the top sieve is placed and the straps with 2 screws is attached. The intensity is adjusted on 60 for 20 minutes. After the analysis, each sieve is analyzed and the bottom with the powder it contains. It is possible to adjust the number and size of sieves according to the needs.

### Calculations

% of powder (for a given size)=(total weight−tare weight)/weight sample*100

### Determination of Enthalpy

This determination is performed by Differential scanning calorimetry (DSC).

The thermal behavior of the sample is evaluated using a Q1000 Differential calorimetric Analyzer (TA Instruments).

The conditions used for the calorimetric analysis are as follows:
10% protein solution—hydration 1 hour
samples of 11 mg, placed in a hermetically sealed aluminum capsule,
temperature rise from 10 to 120° C., at a speed of 5° C./min,
empty capsule used as a reference.

A minimum of two repetitions are carried out per sample.

The temperature of the beginning of the peak (Tonset), the temperature of the maximum of the peak (Tmax) and the enthalpy (ΔH) are determined from the curves recorded by the analyzer.

### Example 1: Method for Extracting Pulse Proteins According to an Embodiment of the Present Invention

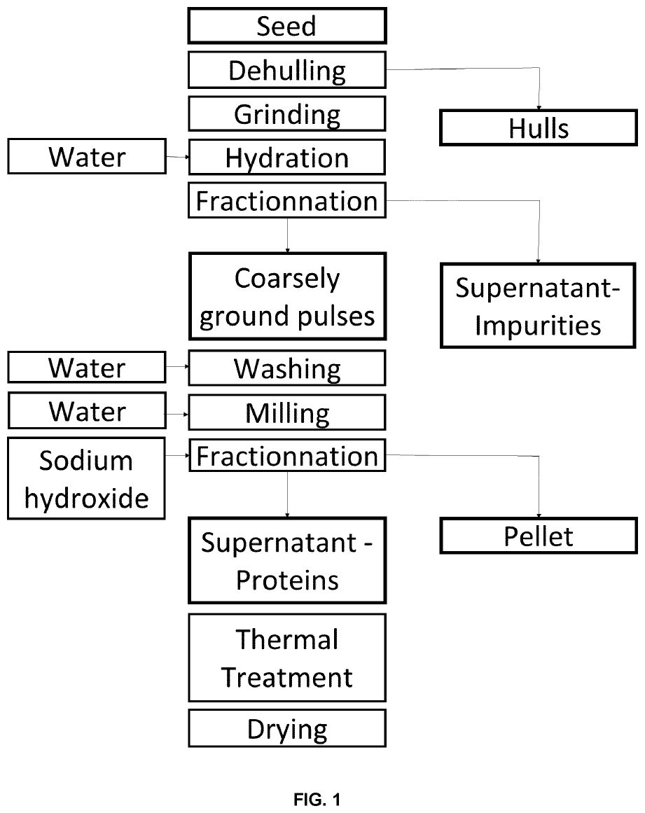

This example was performed following the protocol as schematically represented in FIG. 1.

9.4 kg of faba bean harvested dry, herein referred as “dry faba bean” (having a dry matter content based on total weight of dry faba bean of about 87%) were sieved and destoned by passage through a destoner. Subsequently, the faba beans were dehulled in a dehuller.

The dehulled faba bean were first coarsely ground using a crusher from Avimat (AVI MAT-ELE). Then 7.5 kg of the coarsely ground faba bean were brought into contact with drinkable water (67.5 kg) and subjected to hydration in a tank. The hydration was carried out in a tank at a temperature of about 20° C. for 75 min. After hydration, the coarsely ground faba bean were separated from the hydration medium using a perforated rotating drum and washed in situ with 33 kg of drinkable water to remove the remaining soluble impurities. The coarsely ground faba bean had a dry matter content of about 36.1% (by weight).

After this washing, an amount of 16.4 kg of the coarsely ground faba beans were subjected to wet milling. Prior to the milling, additional drinkable water was added such that the final composition had a dry matter content of about 14.4% (on weight basis). During the milling step, the pH was adjusted to 8.0 by addition of sodium hydroxide.

After milling and pH adjustment, the milled faba bean paste was subjected to centrifugal decantation (4000 rotation per minute; 5 min). The supernatant (29.7 kg) containing proteins had a dry matter content of about 5.5% (on weight basis). The decanted solid fraction (11.2 kg) was washed with a mass of 13.6 kg of water. The resulting suspension was then separated by centrifugation. A mass of 14.6 kg of this second supernatant (Dry matter=1.1%) and a mass of decanted solid of 10.2 kg were recovered.

The supernatants were then subjected to heat treatment by heating to about 72° C. by means of tubular heat exchanger, and maintaining slurry at a temperature of about 72° C. for 15 seconds.

Finally, the heat treated supernatants were spray dried on a NIRO Minor spray drying tower. The inlet temperature of the spray dryer was about 195° C. and the outlet temperature was about 81° C. The dry matter was found to be 94.1% and the protein content was 90.6% on dry matter basis.

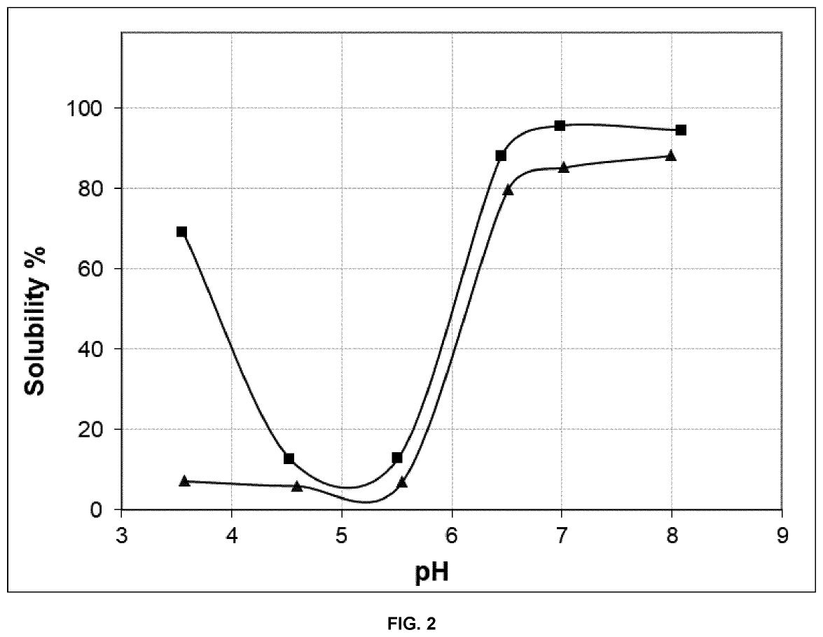

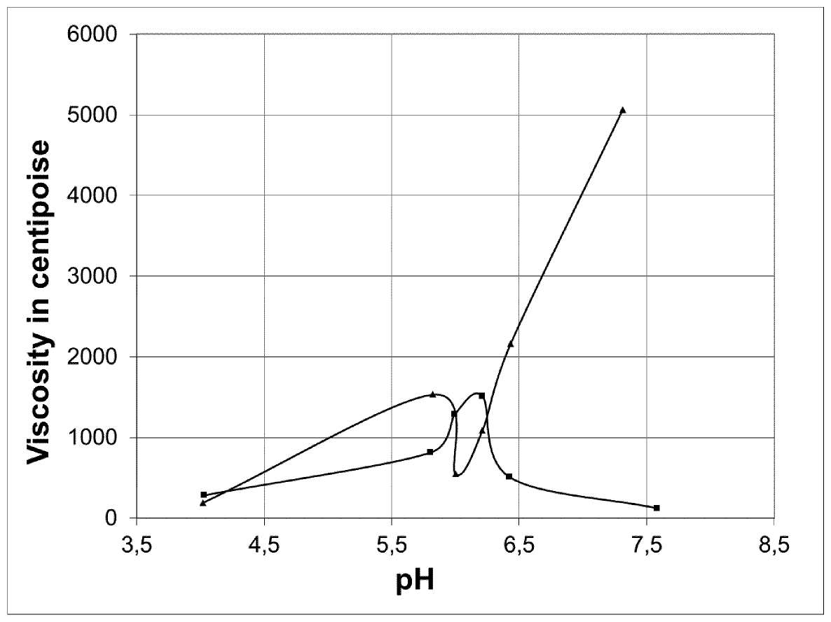

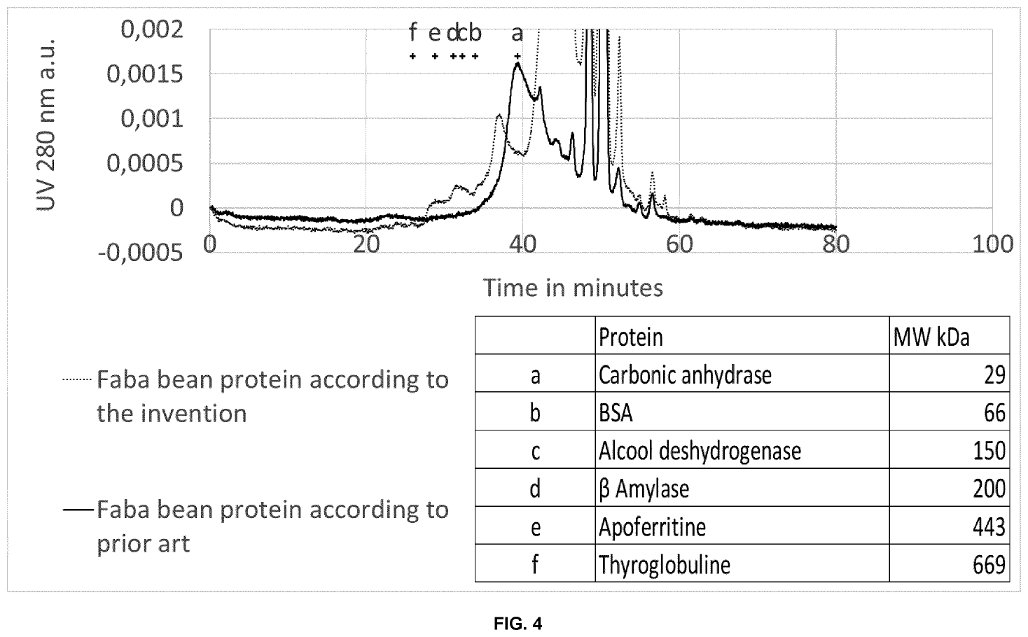

FIG. 2 show the solubility profile of a faba bean protein composition according to the example 1 (▪) and according to a method including isoelectric precipitation (▴). FIG. 3 show the viscosity profile of faba bean protein composition according to the example 1 (▪) and according to a method using isoelectric precipitation (▴). Finally FIG. 4 show the HPSEC profile of faba bean protein composition according to the example 1 and according to a method using isoelectric precipitation.

### Example 2: Analysis by Differential Scanning Calorimetry (DSC)

The thermal behavior of the sample is evaluated using a Q1000 Differential Calorimetric Analyzer (TA Instruments).

The conditions used for the calorimetric analysis are as follows:
10% protein solution—hydration 1 hour
samples of 11 mg, placed in a hermetically sealed aluminum capsule,
temperature rise from 10 to 120° C., at a speed of 5° C./min,
empty capsule used as a reference.

A minimum of two repetitions are carried out per sample.

The temperature of the beginning of the peak (Tₒₙₛₑₜ), the temperature of the maximum of the peak (Tₘₐₓ) and the enthalpy (ΔH) are determined from the curves recorded by the analyzer.

Sample 1 corresponds to faba bean protein composition according to the invention and

sample 2 corresponds to faba bean composition according to the prior art, using isoelectric precipitation.

| Sample | Enthalpy ΔH J/g | T° onset ° C. | T° pic ° C. |
|---|---|---|---|
| 1 | 7.8 | 71.0 | 87.4 |
| 2 | 4.0 | 80.2 | 87.6 |

Undenatured proteins generally show a peak (peak apex) between 80-90° C. We can see in these samples that they all have this characteristic peak.

The enthalpy of a native protein is usually around 9-10 J/g. However, this enthalpy is dependent on dry matter and protein content. Sample 1 is less denatured than sample 2.

1. A pulse protein composition characterized by having:
a protein content of at least 60 wt % based on dry matter,
a nitrogen solubility index at a pH ranging from 4.5 to 5.5 of at most 20%, preferably of at most 15% and a nitrogen solubility index at pH of (at most) 3.5, preferably at pH of (at most) 3.8 of at least 20%, preferably at least 30%, such as at least 40%. (preferably as measured on an aqueous composition comprising 3 wt % of said pulse protein composition based on the total weight of the aqueous composition).

2. The pulse protein composition according to claim 1, characterized in that by having a nitrogen solubility index at a pH of at least 7 (or ranging from 7 to 8) of at least 70%, preferably of at least 80%.

3. The pulse protein composition according to claim 1, characterized in that by having an enthalpy of at least 4.5 (ΔH J/g), preferably of at least 5.5 measured by DSC (Differential scanning calorimetry).

4. The pulse protein composition according to claim 1, having a viscosity below 2000 cP at pH 6.5, preferably 1800 cP at pH 6.5.

5. The pulse protein composition according to claim 1, characterized in that the pulse protein composition has an emulsion capacity of at least 600 g oil/g protein.

6. The pulse protein composition according to claim 1, characterized in that the pulse protein composition has a gel strength of at most 150 g, preferably at most 130 g.

7. Method for extracting pulse protein composition, the method comprising the following steps:
(a) coarsely grinding pulses so as to obtain coarsely ground pulses;
(b) bringing coarsely ground pulses into contact with an aqueous solution in order to form an aqueous composition comprising coarsely ground pulses;
(c) leaving the coarsely ground pulses to hydrate in said aqueous composition thereby obtaining hydrated coarsely ground pulses;
(d) removing aqueous solution from the aqueous composition comprising hydrated coarsely ground pulses;
(e) wet milling said hydrated coarsely ground pulses; thereby obtaining milled pulses;
(f) fractionating said milled pulses so as to obtain pulse protein composition.

8. The method according to claim 7, wherein
at most 25% of coarsely ground pulses in step (a) have a diameter equal or less than 500 μm, preferably at most 20% of coarsely ground pulses in step (a) have a diameter equal or less than 500 μm, more preferably at most 15% of coarsely ground pulses in step (a) have a diameter equal or less than 500 μm;
10 to 50% of coarsely ground pulses in step (a) have a diameter equal or more than 2 mm, more preferably 25 to 40% of coarsely ground pulses in step (a) have a diameter equal or more than 2 mm.

9. The method according to claim 7, wherein step (c) comprises leaving the coarsely ground pulses to hydrate at a pH of the aqueous solution ranging from 4 to 7, preferably from 4.5 to 6.5. This pH adjustment can be performed using any suitable acid, such as hydrochloric acid, citric acid, lactic acid.

10. The method according to claim 7, wherein step (c) comprises leaving the coarsely ground pulses to hydrate for at least 5 minutes and at most 5 hours.

11. The method according to claim 7, wherein fractionating said milled pulses in step (f) comprises subjecting said milled pulses to one or more separation steps, preferably one or more decantation steps, preferably one or more centrifugal decantation steps.

12. Method according to claim 7, wherein during step (c), the pulses are subjected to fermentation.

13. Pulse protein composition obtainable by the method according to claim 7.

14. An edible composition, preferably a food or feed product, comprising the pulse protein composition according to claim 1.

15. Use of a pulse protein composition according to claim 1 in food or feed products, preferably, in dairy products, confectionary products, beverages, acidic beverages, meat products, vegetarian products, food supplements, nutritional products destined to weight control, sports, medical food and food for elderly, and bakery food products.
